(19) United States
(12) Patent Application Publication
(10) Pub. No.: US 2011/0001687 A1
(43) Pub. Date: Jan. 6, 2011

(54) Dual display device using single display controller

(76) Inventors: Sudharshan Srinivasan, Fremont, CA (US); Kothandraman Ramchandran, Fremont, CA (US); Jai Kumar, Cupertino, CA (US)

Correspondence Address: SUDHARSHAN SRINIVASAN, 5496 GOLUBIN COMMON, FREMONT, CA, 94555, US

(21) Appl. No.: 12/459,713

(22) Filed: Jul. 6, 2009

(51) Int. Cl. G09G 5/00

(52) U.S. Cl. 345/3.1; 345/1.1; 455/566

(57) ABSTRACT

A dual display device is described where a single display controller (32) is used to support both displays. This is done by using the smart panel display mode of the display controller and connecting to two displays that both support smart panel display mode along with chip select signals (40) that controls when each display should process the signals. This method enables display in simultaneous display mode and mutually exclusive display mode. Using a single display controller to support an additional display enables use of existing smartphone application processors (33) that already provide an embedded display controller supporting smart panel display mode. Hence an extra display can be easily added to existing smartphone implementation with ease, without extensive redesign to schematics, power budget and associated protocols for supporting a second display controller.

### CROSS-REFERENCE TO RELATED APPLICATIONS

Not applicable

### FEDERALLY SPONSORED RESEARCH

Not applicable

### SEQUENCE LISTING OR PROGRAM

Not applicable

### BACKGROUND OF THE INVENTION

1. Field of Invention

The present invention generally relates to devices with dual displays of varying display refresh rates and specifically to devices using a single display controller to provide simultaneous and mutually exclusive display usage of the two displays.

2. Prior Art

Dual display devices such as cellular phones use two different kinds of displays. One display may be of smaller size and resolution than the other. The smaller display is usually used for quick access to information whereas the larger display with higher resolution is used for complete information with full interactivity.

Most such devices have independent display controllers to control each of these displays. This is because a display controller that supports a lower resolution smaller display is not capable of driving a larger display with higher display resolution. Hence if there is a need for supporting two large displays in the same device, there is no solution known in prior art except using two display controllers. This will eliminate the use of most cellular phone application processors that provide a single display controller that can control only one large display. This is a very big limitation as many smartphone application processors may need to be used in tandem with other displays that may be larger or more power efficient. But the fact that other displays will need an additional display controller will mandate a redesign of the mobile device to support one external display controller and another that is embedded inside of the application processor.

Display controllers are hardware elements that produce and consume hardware signals to and from displays. Each hardware element consumes power and hence results in increased battery usage. In addition, each new hardware element adds to bill of materials of the end product and adds to the complexity of schematic. Thus adding another display controller to an existing schematic is a non-trivial change.

Hence there is a need for a method to enable a single display controller that is embedded in an application processor to be used across multiple displays either in simultaneous display mode or mutually exclusive display mode. This enables addition of a second display to existing designs without significant redesigns or increase in bill of materials.

Smartphones offer larger displays to offer a better view of internet content, but such displays are too big for a small form factor device. Hence there are some cellular phones in prior art that offer dual displays that can operate in tandem, to display a larger web page across the two displays while maintaining a smaller form factor. But such devices also use two display controllers.

Other devices that use two displays use different kinds of displays with different refresh rates. Such devices use low refresh rate displays for the first display, such as electronic paper based displays for power efficiency and regular displays for displaying high refresh rate content.

But all such devices use two different display controllers to control the two displays. This adds to the cost of the device and power consumption. In addition coordinating display buffer contents across two display controllers adds to additional complexity in the schematic. Hence there is a need for a system that uses a single display controller to control both displays.

Current display controllers support two kinds of displays, one that supports smart panel displays and the other regular displays.

Smart panel displays do not need refreshing signals from the host display controller, as they have a driver chip with embedded random access memory (RAM) and an embedded controller so that display refresh can be done locally at the display itself with the screen data that was last sent to it. Hence after a screen full of data is transferred into a smart panel display, there is no need for the host display controller to send additional signals to keep the screen contents visible.

Regular displays do not have an embedded chip and hence need to be refreshed from the display controller of the host device. Hence a display controller used for a regular display needs to generate signals at a rapid rate to keep the screen contents visible without flickers.

But a device that is made up of two displays, one of which may be a smart panel display and the other a regular display will not be able to use a single display controller to control both displays as the refresh rates of two displays may not be compatible. Hence there is a need for a method to enable both displays to be controlled by a single controller even though the refresh rates may be different.

For further descriptions, a smart panel display is considered equivalent to an electronic paper display as electronic paper display also does not need an update after a screen full of data is received.

Following paragraphs in current section describe relevant prior art in this field.

Prior art US Doc 20080072163 describes a dual display device that can be made of displays of differing frame refresh rates. But this prior art mandates use of multiple display controllers one for each display. Hence this system cannot be used with application processors that embed a single display controller that are most commonly used in cellular phones unless such phones are redesigned significantly.

Prior art US Doc 20070075915 describes a multi display device with one of them using a touch panel to detect the boundaries of user interaction. This method describes ways to transfer data between two displays as the need maybe. But this does not address the need of using a single display controller to control both displays that may be in simultaneous display mode or in exclusive display mode.

As can be seen from above, all known prior arts suffer from some limitations in offering a solution to support dual displays without significant changes to existing hardware.

3. Objects and Advantages

Accordingly, several objects and advantages of the present invention are:
a) to provide a method that enables adding a second display to an existing smartphone design without adding to bill of materials cost;
b) to provide a dual display device where both displays can be controlled by a single display controller embedded in the device; and
c) to provide an external display that can be controlled by the embedded display controller without significant redesign of device schematics or increase in bill of materials.

### SUMMARY

In accordance with present invention, a display controller sharing method is described that enables use of a single display controller across two displays even though the displays may require differing frame refresh rates.

A smartphone application processor usually provides a single display controller supporting two modes of operation, a smart panel display mode and a regular display mode.

The present invention makes use of smart panel mode of the display controller along with selective use of chip select signals to control display contents of two displays to achieve the above mentioned sharing of a single display controller and control the two displays.

Setting the display controller to regular display mode makes it send refresh signals into a display continuously after the display is powered on, but when set to smart panel mode, a display is sent data only when there is an update in the frame buffer.

Hence setting the display controller to smart panel mode enables controlling both displays with a single set of signals from the display controller passed onto both displays.

There are two types of frame buffer content that need to be addressed. Content that generates high frame rate due to frequent changes, and content that seldom changes and produces a low frame rate.

Content which is frequently changing is sent only to a display with higher refresh rate and the lower refresh rate display is turned off using a chip select signal or a software reset. When frame buffer contents are not changing, the display with lower refresh rate is turned on and contents of last frame buffer are updated in both displays.

This scheme enables selective use of both high refresh rate display and lower refresh rate display in simultaneous display mode or mutually exclusive display mode using a single display controller.

Such a scheme is not possible in regular display mode of a display controller as output signal lines are constantly engaged with refresh frames and there is no way to detect whether these output signals are due to content change in frame buffer or refresh related output signals. Hence it will not be possible to turn on and off a display of lower resolution when needed in regular display mode.

Hence combining the use of smart panel display mode of a display controller with selective turning on and off of a lower refresh rate display, enables use of a single display controller to control two displays with differing refresh rates without the need for any new components. All of this can be done just in software if display signals of first display are available externally.

Changes needed to schematic of an existing device are minimal without additional need for new components. Display signals are branched out to a second display along with a chip select signal that is tied to the application processor. No more changes are needed such as a new display controller and schematic changes to connect display buffer to the new display controller, and corresponding clock etc.

Hence this method of using a single display controller provides an unobvious result that any smartphone in the market can be easily adapted to support a lower refresh rate display such as an electronic paper display without the need of additional bill of materials or extensive schematic change.

### DRAWINGS—FIGURES

FIG. 1 shows prior art illustration of mobile device supporting two displays using two LCD controllers.

FIG. 2 shows the mobile device of present invention that support two displays with a single LCD controller.

### DRAWINGS—REFERENCE NUMERALS

31 High frame rate display

32 embedded LCD controller

33 application processor

34 embedded LCD controller bus

35 Low frame rate display

36 embedded display RAM

37 external LCD controller

38 external LCD controller bus

39 application processor system bus

40 chip select one

41 chip select two

### DETAILED DESCRIPTION OF PREFERRED EMBODIMENT

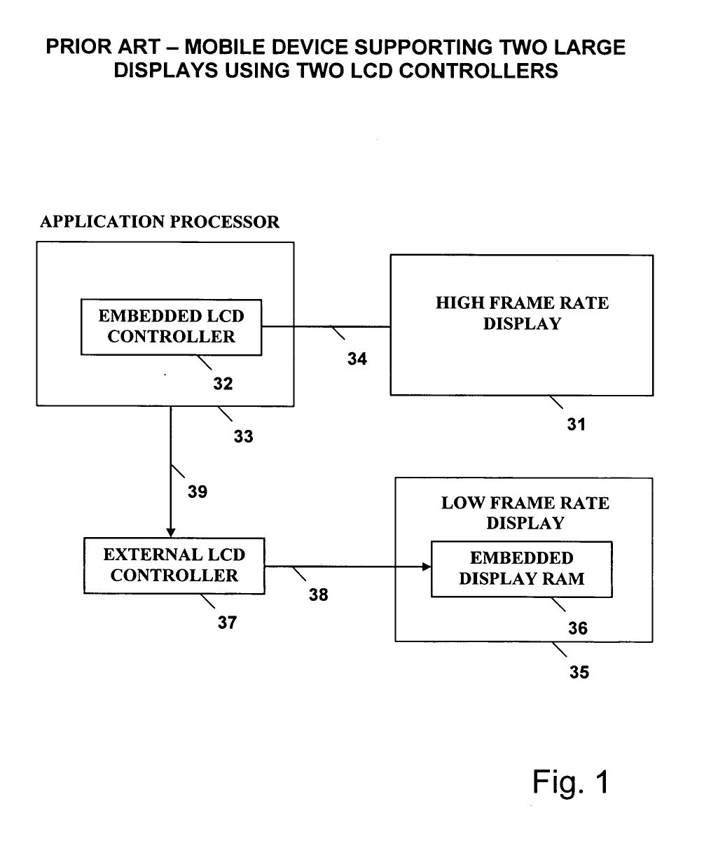

FIG. 1 shows prior art illustration of a mobile device supporting two large displays using two LCD controllers. High frame rate display 31 is connected to embedded LCD controller 32 of application processor 33 using embedded LCD controller bus 34 which operates in RGB interface mode. Low frame rate display 35 with embedded display RAM 36 is connected to external LCD controller 37 using external LCD controller bus 38 which operates in smart panel interface mode. External LCD controller 37 is connected to application processor 33 using application processor system bus 39. Prior art solutions mandate external LCD controller 37 to support low frame rate display 35 because, embedded LCD controller 32 is unable to support two displays with different frame rates simultaneously by interconnecting embedded LCD controller bus 34. This limitation increases the development, manufacturing and operation cost of the device. Development cost is increased due to change in design, manufacturing cost is increased due to additional components and operation cost is increased due to increased power consumption.

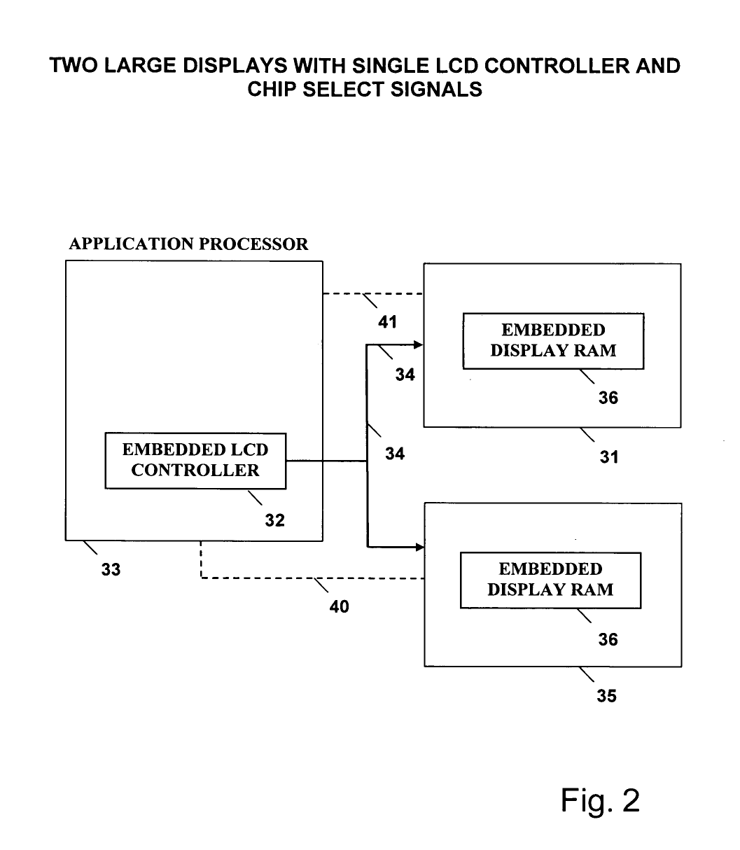

FIG. 2 shows a mobile device of present invention that support two displays with differing refresh rates using a single liquid crystal display (LCD) controller. High frame rate display 31 and Low frame rate display 35 are both connected to embedded LCD controller 32 using embedded LCD controller bus 34. Additionally, chip select one 40 and chip select two 41 are connected to high frame rate display 31 and low frame rate display 35 respectively with application processor 33. This arrangement enables embedded LCD controller 32 to operate both high frame rate display 31 and low frame rate display 35 simultaneously or individually. In order to operate simultaneously, embedded LCD controller bus 34 is programmed to operate in smart panel mode. Both high frame rate display 31 and low frame rate display 35 support embedded display random access memory (RAM) 36 and hence are capable of refreshing locally. To send display data to low frame rate display 35, application processor 33 first asserts chip select two 41 and then embedded LCD controller 32 is able send display data to low frame rate display 35 through embedded LCD controller bus 34 without affecting high frame rate display 31. Whereas, display data to high frame rate display 31 is sent after asserting chip select one 40 without affecting what is displayed in low frame rate display 35.

If only high frame rate display 31 needs to be used, then embedded LCD controller bus 34 can be operated in RGB interface mode instead of smart panel mode. High frame rate display 31 has its embedded display RAM 36 turned off by software command. This enables to minimize power consumption because rapidly changing display data requires frequent update, making embedded display RAM 36 ineffective. Chip select two 41 is not asserted and low frame rate display 35 is turned off by software or hardware control means.

The displays can also be automatically activated based on the content to be shown. For example, if a web page is being viewed with static content then low frame rate display 35 can be activated and if the web page shows video content, then high frame rate display 31 is activated and low frame rate display 35 is deactivated. The chip select signal can also be implemented using software register settings in which case display data lines maybe controlled just using register settings and hence additional hardware lines may be avoided. But most displays and display controllers support chip select hardware lines, and hence will not add to additional circuit changes.

Advantages

From the description above a number of advantages of this wireless system become evident:
a) a method is provided that enables adding a second display to an existing smartphone design without adding to bill of materials cost;
b) a dual display device is provided where both displays can be controlled by a single display controller embedded in the device; and
c) an external display is provided that can be controlled by the embedded display controller without significant redesign of device schematics or increase in bill of materials.

### CONCLUSION, RAMIFICATIONS AND SCOPE

Accordingly, the reader will see that support for second display may be provided for existing smartphones or other devices that provide an application processor with a single display controller using the smart panel display mode of the display controller, hence eliminating the need for extensive hardware change.

Although the description above contains many specificities, these should not be construed as limiting the scope of invention but merely as providing illustrations of some of the presently preferred embodiments of this invention. Thus the scope of this invention should be determined by appended claims and their legal equivalents, rather than by example given.

We claim:

1. A method of adding a second display to a mobile device having one display controller, comprising:
a) setting said display controller to smart panel display mode wherein said smart panel display mode of said display controller enables controlling displays with embedded chips at said displays to do local refreshing at said displays;
b) routing display signals of first display to a second display that may have a different refresh rate;
c) setting first display to smart panel display mode such that smart panel based signals from said display controller are accepted at said first display;
d) setting second display to smart panel display mode such that smart panel based signals from said display controller are accepted at said second display;
e) routing graphics output of software applications to frame buffer associated with said display controller;
f) detecting change in said frame buffer contents;
g) turning first display on and turning second display on based on said detection of change; and
h) detecting that frame buffer contents are not changing and turning second display to a state where it will ignore any new signals.

2. The method of adding a second display of claim 1, wherein said mobile device is selected from group consisting of mobile phone, smartphone, and personal digital assistant.

3. The method of adding a second display of claim 1, wherein said display controller is embedded in an application processor.

4. The method of adding a second display of claim 1, wherein said application processor supports smart panel display mode and regular display mode wherein said smart panel display mode of said display controller enables controlling displays with embedded chips to do local refreshing at said displays, and said regular display mode of said display controller enables controlling displays without embedded chips by sending refresh signals from said display controller to said displays.

5. The method of adding a second display of claim 1, wherein said signals are comprised of control signals, and data signals.

6. The method of adding a second display of claim 1, wherein said setup to ignore said signals in said second display is accomplished using signals selected from group consisting of chip select signals, and register setting signals.

7. The method of adding a second display of claim 1, wherein said first display is selected from group consisting of liquid crystal display, thin film transistor display, plasma display, and organic light emitting diode display.

8. The method of adding a second display of claim 1, wherein said second display is selected from group consisting of liquid crystal display, thin film transistor display, plasma display, organic light emitting diode display, and electronic paper display.

9. A mobile device supporting dual display using single display controller comprising:
a) display controller supporting smart panel display mode wherein said smart panel display mode of said display controller enables controlling displays with embedded chips at said displays to do local refreshing at said displays;
b) first display capable of receiving smart panel signals from said display controller;
c) branch out hardware lines from connection lines between said first display controller and said first display to enable connecting a second display to said branch out hardware lines, wherein said second display supports smart panel mode of operation;
d) frame buffer associated with said display controller; and
e) frame buffer change, and no change detection software module.

10. The device of claim 9, wherein said mobile device is selected from group consisting of mobile phone, smartphone, and personal digital assistant.

11. The device of claim 9, wherein said display controller is embedded in an application processor.

12. The device of claim 11, wherein said application processor supports smart panel display mode and regular display mode, wherein said smart panel display mode of said display controller enables controlling displays with embedded chips to do local refreshing at said displays, and said regular display mode of said display controller enables controlling displays without embedded chips by sending refresh signals from said display controller to said displays.

13. The device of claim 9, wherein said signals are comprised of control signals, and data signals.

14. The device of claim 9, wherein said first display is selected from group consisting of liquid crystal display, thin film transistor display, plasma display, and organic light emitting diode display.

15. The device of claim 9, wherein said second display is selected from group consisting of liquid crystal display, thin film transistor display, plasma display, organic light emitting diode display, and electronic paper display.

16. A method of automatically switching content routing to appropriate display in a device using a single display controller to control two displays, wherein first display supports high refresh rate and second display supports low refresh rate, wherein said high refresh rate is greater than fifteen frames per second and said low refresh rate is less than fifteen frames per second, comprising:
a) identifying content that needs high refresh rate;
b) activating said display with higher refresh rate;
c) deactivating said display with lower refresh rate; and
d) routing graphics content of applications to frame buffer associated with said display controller of said device.

17. The method of automatically switching content of claim 16, further comprising:
a) identifying content that needs low refresh rate;
b) activating said display with lower refresh rate;
c) deactivating said display with higher refresh rate;
d) routing graphics content of applications to frame buffer associated with said display controller of said device;

18. The method of automatically switching content of claim 17, further comprising:
a) identifying content that needs low refresh rate;
b) activating said display with lower refresh rate;
c) activating said display with higher refresh rate;
d) routing graphics content of applications to frame buffer associated with said display controller of said device;

19. The method of automatically switching content of claim 16, wherein said content needing high refresh rate is selected from group consisting of video content and interactive graphics user interface content.

20. The method of automatically switching content of claim 16, wherein said content needing low refresh rate is selected from group consisting of web page content and electronic book content.
